(19) United States
(12) Patent Application Publication
(10) Pub. No.: US 2007/0164171 A1
(43) Pub. Date: Jul. 19, 2007

(54) WATER SUPPLY PASS-THROUGH APPARATUS

(76) Inventor: William Costas, Brooksville, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/687,692

(22) Filed: Mar. 19, 2007

Related U.S. Application Data
(62) Division of application No. 10/866,669, filed on Jun. 15, 2004.
(60) Provisional application No. 60/479,449, filed on Jun. 19, 2003.

(51) Int. Cl. F16L 3/08

(52) U.S. Cl. 248/65

(57) ABSTRACT

A pair of specially designed plates that are mounted to the framing of a screened enclosure, enabling the installation of a hose bib and hose bib to garden hose adapter, providing a water supply through the screen of the enclosure. This provides a garden hose connection and water flow control point within the screened enclosure. An ordinary garden hose is attached to a hose bib outside the screened enclosure and to the hose bib to garden hose adapter providing the water supply.

### RELATED APPLICATION

This application is a divisional of U.S. patent application Ser. No. 10/866,669 filed Jun. 15, 2004, which claims the benefit of U.S. provisional patent application 60/479,449 filed Jun. 19, 2003.

### BACKGROUND OF THE INVENTION

The present invention provides a unique screen pass through apparatus that provides a watering hose connection inside a screened enclosure such as used to enclose pools. Generally, most homes that have an in ground pool installed with a screened enclosure do not have a hose bib installed within the enclosure. It is awkward to bring a hose in through the enclosure door for the purpose of filling lost water in the pool, watering decorative plants, cleaning the patio floor, etc. because 1) the hose gets caught under the door, 2) pets try to escape through the opened enclosure door, and 3) bugs enter the screened enclosure through the opened door defeating the purpose of the enclosure.

The object of the present invention is to provide an extension apparatus mounted to the framing of the screened enclosure providing a hose bib within the enclosure for watering needs. The apparatus is connected to a hose bib outside the enclosure which supplies the water via an ordinary garden hose.

### SUMMARY OF THE INVENTION

A unique hose bib extension apparatus mounted to the frame of a screened enclosure providing a garden hose connection and water flow control point within the screened enclosure. The assembly includes two specially designed plates for mounting to the screened enclosure frame enabling the mounting of a hose bib and hose bib to garden hose adapter providing a water supply through the screen of the enclosure. An ordinary garden hose is attached to a hose bib outside the screened enclosure and to the hose bib to garden hose adapter providing the water supply.

### BRIEF DESCRIPTION OF THE DRAWINGS

FIG. 1 is a side view of the screen pass through apparatus mounted to the screened enclosure.

FIG. 2 is the front view of the screen pass through apparatus mounted to the screened enclosure.

FIG. 3 is the back view of the screen pass through apparatus mounted to the screened enclosure.

FIG. 4 is the right side view of the L mounting bracket.

FIG. 5 is the left side view of the L mounting bracket.

FIG. 6 is the bottom view of the L mounting bracket.

FIG. 7 is the front view of the L mounting bracket.

FIG. 8 is the front view of the flat mounting bracket.

FIG. 9 is the side view of the flat mounting bracket.

### DETAILED DESCRIPTION OF THE INVENTION

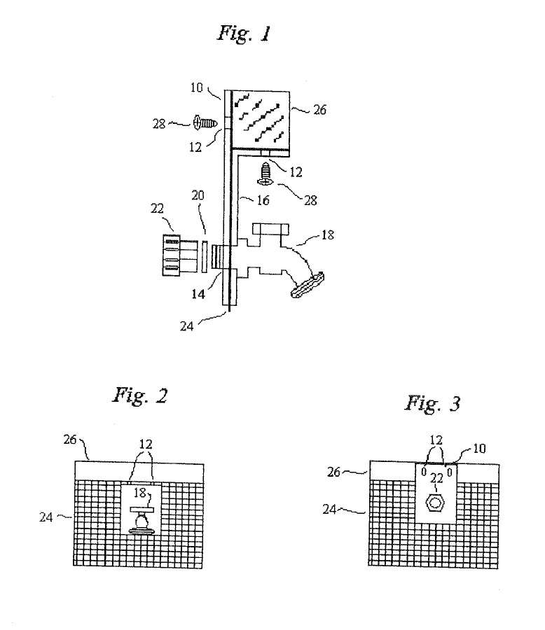

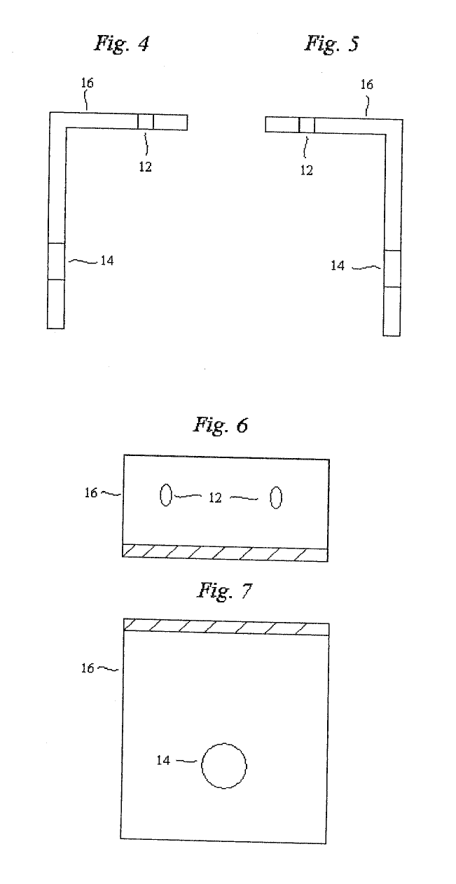

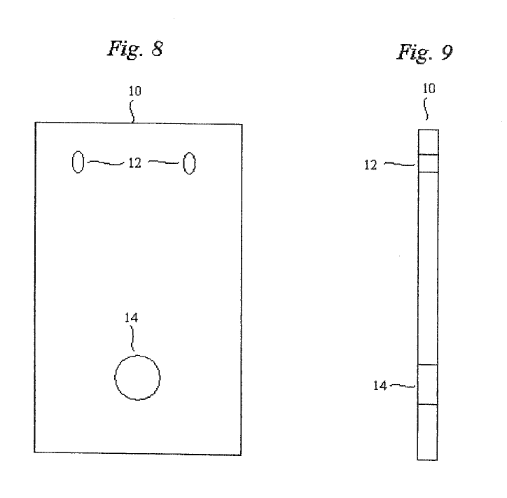

Referring now to the drawings in detail wherein like reference numerals have been used throughout the various figures to designate like elements, there is shown in FIG. 1, the apparatus mounted to the frame 26 of the screened enclosure. The Water Supply Pass-Through Apparatus contains two specially designed mounting plates. The front mounting plate 16 is an L-shaped plate containing two oval screw-mounting holes in the shorter side of the L, and one hose bib-mounting hole in the longer side of the L. he back mounting plate is a flat plate 10 containing two oval screw-mounting holes near the top of the plate, and one hose bib-mounting hole near the bottom of the plate. The hose bib-mounting holes are located in the same position on the flat plate 10 as the L-plate 16 so when they are mounted, the holes line up. The L-plate 12 is mounted to the inside of the screen enclosure. The flat plate 10 is aligned with the L-plate 16 and mounted to the outside of the screen enclosure. The flat plate is mounted using stainless steel screws 28 through the oval mounting holes 12 FIG. 8. The L-plate is mounted using stainless steel screws 28 through the oval mounting holes 12 FIG. 6. A hole the size of the hose bib mounting hold 14 FIG. 7, is cut in the enclosure screening 24 and the hose bib 18 is inserted through the two mounting plates 10 & 12, and the screen 24, and secured to the plates with the washer 20 and the adapter 22. By connecting an ordinary garden hose to the hose bib to hose thread adapter 22, and to a hose bib outside of the screened enclosure, water is supplied to the Water Supply Pass-Through Apparatus. A garden hose can now be connected to the hose bib on the Water Supply Pass-Through Apparatus providing a controlled water supply inside the screened enclosure.

1.-2. (canceled)

3. A mounting bracket system for mounting a hose bibcock to a screened-in enclosure comprising, in combination with said hose bibcock:
means for mounting the hose bibcock through a frame member of a screened-in enclosure, said means for mounting the hose bibcock further comprising bracket members, one of said bracket members being flat for mounting to a cross-frame member of the screened-in enclosure on a generally flush side of the screen enclosure, and another of said bracket members being angles-shaped wherein a first side of the angles-shaped bracket member is adapted for mounting to said cross-frame member of the screened-in enclosure; and
the flat bracket member and the angles-shaped bracket member being adapted to receive the hose bibcock therethrough.

4. The bracket system according to claim 3, further comprising:
a union female hose connection adapter adapted to mechanically engage an inlet end of the hose bibcock wherein said adapter, when tightened compresses each bracket member together with the screen material being compressed therebetween.

5. The bracket system according to claim 3, wherein the flat bracket member and the first side of the angled-shaped bracket member include spaced-apart apertures for facilitating mounting of said brackets to said cross-frame members with screws.

6. A method for securing a hose bibcock to a screened enclosure comprising:
mounting a bracket system for mounting a hose bibcock to a screened-in enclosure comprising, the bracket mounting system comprising, in combination with a hose bibcock:
means for mounting the hose bibcock through a frame member of a screened-in enclosure, said means for mounting the hose bibcock further comprising bracket members, one of said bracket members being flat for mounting to a cross-frame member of the screened-in enclosure on a generally flush side of the screen enclosure, and another of said bracket members being angles-shaped wherein a first side of the angled-shaped bracket member is adapted for mounting to said cross-frame member of the screened-in enclosure; and
the flat bracket member and the angled-shaped bracket member being adapted to receive the hose bibcock therethrough.

7. The method according to claim 6, further comprising:
providing a union female hose connection adapter adapted to mechanically engage an inlet end of the hose bibcock wherein said adapter, when tightened compresses each bracket member together with the screen material being compresses therebetween.

8. The method according to claim 7, further comprising:
mounting the flat bracket member to one side of the cross-frame member on the generally flush side of the screened-in enclosure at the desired location and mounting the angled-shaped bracket member on the other side of the screened-in enclosure such that the holes for the hose bibcock are aligned;
removing the portion of the screen material exposed within the aligned holes after the adapter has been tightened; and
mounting the hose bibcock through said aligned holes and securing it in place with said adapter.

9. The method according to claim 6, wherein the flat bracket member and the first side of the angled-shaped bracket member include spaced-apart apertures for facilitating mounting of said brackets to said cross-frame members with screws.
